(19) United States
(12) Patent Application Publication
(10) Pub. No.: US 2021/0284247 A1
(43) Pub. Date: Sep. 16, 2021

(54) SKID PLATE FOR A VEHICLE

(71) Applicant: Honda Motor Co., Ltd., Tokyo (JP)

(72) Inventors: Jeffrey S. DOBROZDRAVIC, Ostrander, OH (US); Jason W. GRUNDEY, Wapakoneta, OH (US); Scott R. HARVEY, Oswego, NY (US); Samira S. JOHNSON, Dublin, OH (US)

(21) Appl. No.: 16/817,259

(22) Filed: Mar. 12, 2020

(51) Int. Cl. B62D 25/20; B62D 35/02

(52) U.S. Cl. CPC B62D 25/2072; B60K 11/08; B62D 35/02

(57) ABSTRACT

A skid plate adapted to be disposed at an underside of a vehicle is disclosed. The skid plate includes a plate portion, a duct portion, and a screen. The plate portion has a first side adapted to be disposed facing a ground and a second side disposed opposite to the first side. The duct portion is connected to the plate portion and extends away from the plate portion. Further, the duct portion defines a channel for directing a flow of air from the first side to the second side. Also, the screen is disposed at an outlet of the channel to prevent an ingress of debris to the second side.

### BACKGROUND

The disclosed subject matter relates generally to skid plates for vehicles. More particularly, the disclosed subject matter relates to a skid plate disposed at an underside of a vehicle and having a duct portion to facilitate a flow of air from the underside towards an engine and/or a transmission assembly.

Vehicles, generally, include skid plates at an underside of the vehicle to protect engine and/or transmission components from an impact of the protruding road surface or various debris, such as pebbles, when driving on a rough road such as a dirt road. Skid plates, therefore, prevent or restrict a flow of air to the engine and the transmission from an ambient, which may lead to heating of one or more components of the engine and the transmission assembly. In certain scenarios, the skid plates may include one or more openings to allow a passage of cooling air to the engine and the transmission assembly. However, the debris may pass through the one or more opening and hit the engine/or transmission assembly and damage the one or more components of the engine and/or transmission assembly, which is undesirable.

### SUMMARY

In accordance with one embodiment of the present disclosure, a skid plate adapted to be disposed at an underside of a vehicle is provided. The skid plate includes a plate portion having a first side adapted to be disposed facing a ground and a second side disposed opposite to the first side. The skid plate further includes a duct portion connected to the plate portion and extending away from the plate portion. The duct portion defines a channel for directing a flow of air from the first side to the second side. The skid plate also includes a screen disposed at an outlet of the channel to prevent an ingress of debris to the second side.

In accordance with another embodiment of the present disclosure, a vehicle is provided. The vehicle includes a skid plate disposed at an underside of the vehicle. The skid plate has a first end disposed proximate to a front end of the vehicle and a second end disposed distally to the front end. The skid plate includes a plate portion having a first side disposed facing a ground and a second side disposed opposite to the first side. The skid plate further includes a duct portion connected to the plate portion and extending away from the plate portion. The duct portion defines a channel for directing a portion of air flowing the underside of the vehicle to the second side. The skid plate also includes a screen disposed at the outlet of the channel for preventing an ingress of debris to the second side from the underside of the vehicle.

In accordance with yet a further embodiment of the present disclosure a skid plate adapted to be disposed at an underside of a vehicle includes a plate portion having a first side adapted to be disposed facing a ground and a second side disposed opposite to the first side. The skid plate further includes a duct portion connected to the plate portion and extending away from the plate portion. The duct portion defines a channel for directing a flow of air from the first side to the second side. Further, a width of the channel increases along a direction of flow of air through the channel. The skid plate also includes a screen disposed at an outlet of the channel to prevent an ingress of debris to the second side. Furthermore, the duct portion and the screen are integrally formed with the plate portion.

### BRIEF DESCRIPTION OF THE DRAWINGS

Certain embodiments of the present disclosure will be better understood from the following description taken in conjunction with the accompanying drawings in which:

FIG. 1 is a front perspective view depicting a vehicle, in accordance with one embodiment of the present disclosure;

FIG. 2 is a bottom perspective view of the vehicle depicting and a skid plate disposed at an underside of the vehicle, in in accordance with one embodiment of the present disclosure;

FIG. 3 is an enlarged bottom perspective view of the skid plate of FIG. 2 depicting a bottom view of a duct portion of the skid plate, in accordance with one embodiment of the present disclosure; and

FIG. 4 is enlarged top perspective view of the skid plate of FIG. 2 depicting a top view of the duct portion of the skid plate, in accordance with one embodiment of the present disclosure.

### DETAILED DESCRIPTION OF EXEMPLARY EMBODIMENTS

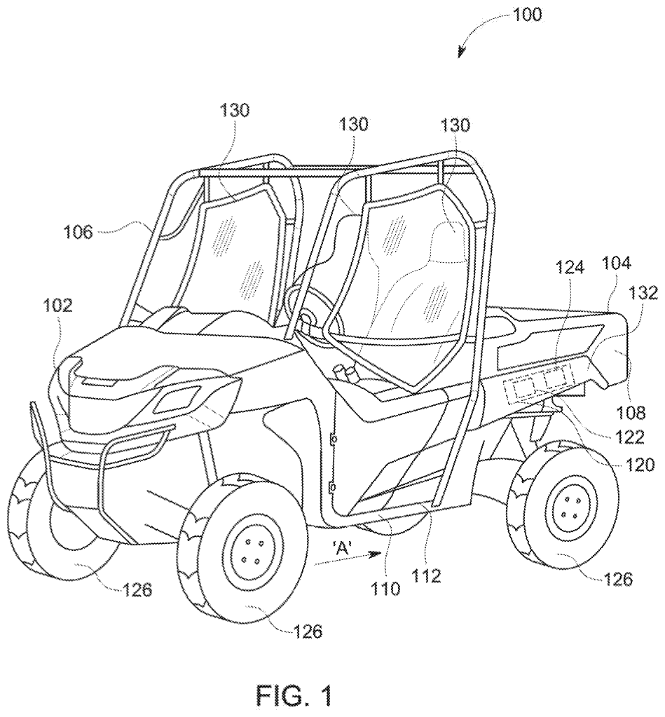

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows. Embodiments are hereinafter described in detail in connection with the views and examples of FIGS. 1-4, wherein like numbers indicate the same or corresponding elements throughout the views.

FIG. 1 illustrates a perspective view of a vehicle, indicated generally at 100, in accordance with one embodiment of the present disclosure. The vehicle 100 is shown as an off-road vehicle. However, vehicles in accordance with alternative embodiments can comprise any variety of vehicles, including automobiles, trucks, vans, recreational vehicles, utility vehicles, agricultural equipment, or construction equipment, for example.

The vehicle 100 may include a front end 102, a rear end 104, a first longitudinal side 106 (hereinafter referred to as a right side 106), a second longitudinal side 108 (hereinafter referred to as a left side 108), and a frame 110 having a plurality of frame members 112 for supporting various component and/or assemblies of the vehicle. The frame members 112 may be tubular and may be connected together by welding or fasteners, for example. The vehicle 100 includes an engine module 120 having an engine 122 and a transmission assembly 124 operatively connected to the engine 122 and adapted to transmit power from the engine 122 to a plurality of traction members 126, such as wheels, of the vehicle 100. In an embodiment, the engine 122 may be an internal combustion engine or an electric motor, of any suitable size and configuration for providing a motive power to the vehicle 100. In one embodiment, the engine module 120 may be supported by the frame 110 at a location behind seats 130. However, in alternative embodiments, the engine module 120 may be located in a central or front portion of the vehicle 100. Further, the vehicle 100 may include an engine cover 132 disposed at a rear portion of the vehicle 100 and covering the engine module 120 and defining an engine compartment.

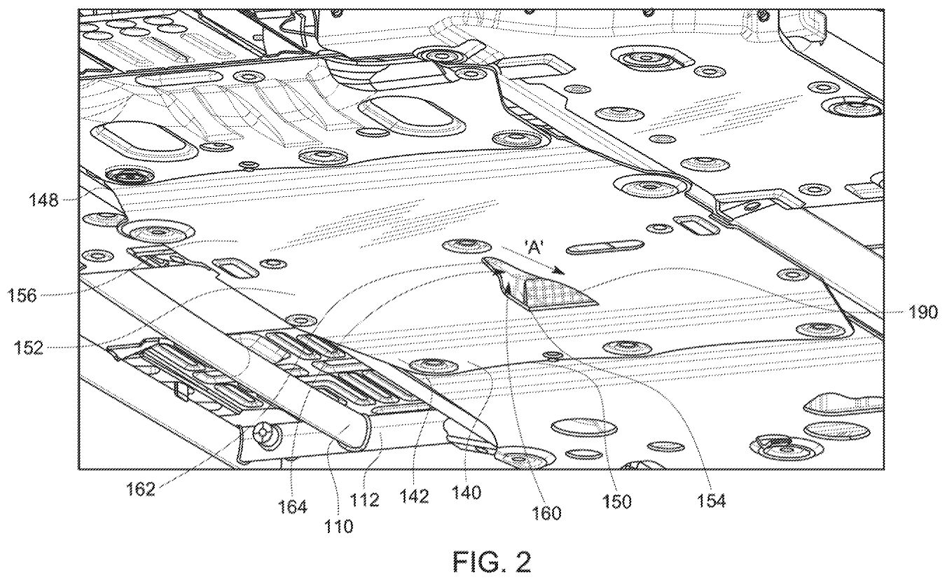

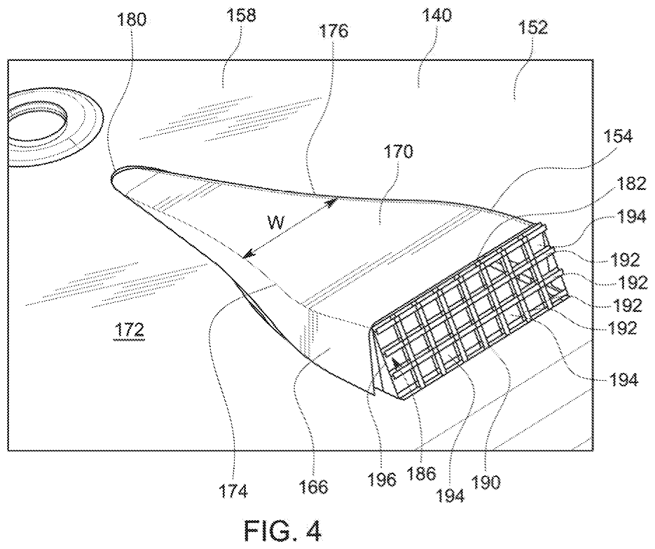

Referring to FIG. 2, the vehicle 100 includes a skid plate 140 disposed at an underside of the vehicle 100 and attached to the frame 110 of the vehicle 100. As shown, the skid plate 140 defines a bottom cover 142 of the engine compartment and may be disposed at the rear portion of the vehicle 100, and include a first end 148 disposed proximate to the front end 102 of the vehicle 100 and a second end 150 disposed distally from the front end 102 and proximate to the rear end 104 of the vehicle 100. Also, the skid plate 140 may extend from the right side 106 of the vehicle 100 to the left side 108 of the vehicle 100 in a lateral direction. Further, referring to FIGS. 2 to 4, the skid plate 140 includes a plate portion 152 and a duct portion 154 extending upwardly and outwardly from the plate portion 152 to direct a flow of air from the underside of the vehicle 100 inside the engine compartment towards the engine 122 and/or the transmission assembly 124. The plate portion 152 includes a first side 156 disposed facing a ground and a second side 158 (shown in FIG. 4) disposed opposite to the first side 156 and defining an interior of the engine compartment. Further, the plate portion 152 includes an elongated opening 160 extending from the first side 156 to the second side 158 through an entire thickness of the plate portion 152. In an embodiment, the elongated opening 160 diverges along a length of the plate portion 152 (i. e. the skid plate 140) in a downstream direction ‘A’ corresponding to a direction of flow of air at the underside of the vehicle 100 when the vehicle 100 is travelling. Accordingly, a width of the elongated opening 160 increases in the downstream direction ‘A’. The elongated opening 160 facilitates a flow of air from the first side 156 of the plate portion 152 to the second side 158 of the plate portion 152 via the duct portion 154.

As shown, the duct portion 154 extends upwardly and outwardly from the second side 158 of the plate portion 152 and defines a channel 164 to direct a flow of air, received from the elongated opening 160, from the first side 156 (i.e. underside of the vehicle 100) to the second side 158 (i.e. inside the engine compartment). In this manner, the elongated opening 160 defines an inlet 162 of the channel 164 through which the air enters the channel 164. As shown, the duct portion 154 is disposed proximate to the rear end 104 of the vehicle 100 relative to the front end 102 of the vehicle 100. Although the duct portion 154 is contemplated to be disposed proximate to the rear end 104, it may be envisioned that a location of the duct portion 154 may depend on a location or position of the engine 122 and/or the transmission assembly 124.

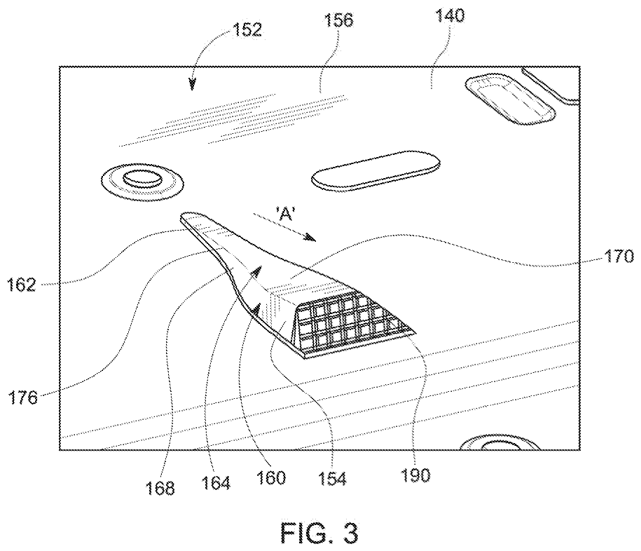

In an exemplary embodiment, the duct portion 154 may include a pair of sidewalls, for example, a first sidewall 166 (shown in FIG. 2) and a second sidewall 168 (shown in FIGS. 2 and 3) disposed spaced apart from the first sidewall 166, and a cover member 170 (best shown in FIG. 4) connected to the first sidewall 166 and the second sidewall 168 and extending at an inclination relative to a surface 172 of the plate portion 152. The first sidewall 166 and the second sidewall 168 extend upwardly and away from the surface 172 of the plate portion 152, and may be, respectively, connected to a first longitudinal edge 174 (shown in FIG. 4) and a second longitudinal edge 176 of the cover member 170. Further, the cover member 170 may include a first longitudinal end 180 connected or abutted to the surface 172 of the plate portion 152, and a second longitudinal end 182 disposed spaced apart from the surface 172 and defining an outlet 186 of the channel 164. Accordingly, the cover member 170 is oriented at an inclination relative to the plate portion 152 in the downstream direction ‘A’. In an embodiment, an angle of inclination of the cover member 170 may vary between 20 degrees to 45 degrees.

Further, as shown, the sidewalls 166, 168 and the cover member 170 extend along a length of the elongated opening 160, in the downstream direction ‘A’, from the first longitudinal end 180 to the second longitudinal end 182. Accordingly, the cover member 170 along with the sidewalls 166, 168 covers the elongated opening 160 from the second side 158, and thereby facilitates in directing a flow of air entering the channel 164 through the elongated opening 160 to the second side 158. In an implementation, a width ‘W’ of the cover member 170 may increase in a direction away from the first longitudinal end 180 towards the second longitudinal end 182 (i.e. in the downstream direction ‘A’). In an embodiment, a shape of the cover member 170 may substantially similar to a shape of the elongated opening 160. Although, the cover member 170 having a varying width is contemplated, it may be appreciated that the width ‘W’ of the cover member 170 may remain constant between the first longitudinal end 180 to the second longitudinal end 182.

Further, the skid plate 140 includes a screen 190 disposed at the outlet 186 of the channel 164 and having a plurality of elongated members 192 (best shown in FIG. 4) defining a plurality of openings 194 (best shown in FIG. 4) to provide a passage to air exiting the channel 164 and to prevent ingress of debris, such as, pebbles, dirt, or any other debris having a size greater than predetermined size, from underside of the vehicle 100 (i.e. the first side 156 of the plate portion 152) to the engine compartment (i.e. the second side 158) through the channel 164. For so doing, a size of each opening 194 is selected to be smaller than the predetermined size. Further, the screen 190 includes an outer periphery 196 connected with the sidewalls 166, 168, the cover member 170, and the surface 172 of the plate portion 152. Accordingly, the screen 190 that extends outwardly and upwardly from the plate portion 152 is engaged/attached/coupled with the duct portion 154 such that the screen 190 covers the outlet 186 of the channel 164. In an embodiment, the screen 190 may be integrally formed with the plate portion 152 and/or the duct portion 154. Alternatively, the screen 190 may be a separate structure and is attached at the outlet 186 by using fasteners or any other attachment means know in the art. In an embodiment, the skid plate 140 is formed by using an injection molding technique, and in such a case, the screen 190 is integrally formed with the plate portion 152 and the duct portion 154. Further, in certain implementations, the screen 190 may be disposed outside the channel 164. Alternatively, the screen 190 may be disposed inside the channel 164 proximate to the outlet 186 of the channel 164. In certain scenarios, the screen 190 may be disposed at the inlet 162 of the channel 164 covering the elongated opening 160 to prevent an ingress of the debris inside the channel 164, and therefore, prevents an ingress of debris to the second side 158 (i.e. engine compartment) through the channel 164. In this manner, the skid plate 140 facilitates a passage of air towards the engine 122 and/or the transmission assembly 124 from an ambient to provide cooling to one or more components of the engine 122 and/or the transmission assembly 124 disposed on the second side 158, while preventing a passage of the debris to the second side 158, and thereby preventing damage to the one or more components of the engine 122 and/or the transmission assembly 124.

The foregoing description of embodiments and examples has been presented for purposes of illustration and description. It is not intended to be exhaustive or to limit the invention to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the invention is, of course, not limited to the examples or embodiments set forth herein, but can be employed in any number of applications and equivalent devices by those of ordinary skill in the art. Rather it is hereby intended the scope of the invention be defined by the claims appended hereto.

What is claimed is:

1. A skid plate adapted to be disposed at an underside of a vehicle, the skid plate comprising:
a plate portion having a first side adapted to be disposed facing a ground and a second side disposed opposite to the first side;
a duct portion connected to the plate portion and extending away from the plate portion, the duct portion defines a channel for directing a flow of air from the first side to the second side; and
a screen disposed at an outlet of the channel to prevent an ingress of debris to the second side.

2. The skid plate of claim 1, wherein the duct portion includes a cover member extending at an inclination relative to the plate portion and including a first longitudinal end connected to the plate portion and a second longitudinal end disposed spaced apart from the plate portion and defining the outlet therebetween.

3. The skid plate of claim 2, wherein the duct portion includes a pair of sidewalls disposed spaced apart from each other and extending away from the plate portion to the cover member.

4. The skid plate of claim 2, wherein a width of the cover member increases from the first longitudinal end to the second longitudinal end.

5. The skid plate of claim 1, wherein the plate portion defines an elongated opening extending through the plate portion to facilitate an inlet of air into the channel from the first side, wherein the elongated opening diverges along a length of the plate portion.

6. The skid plate of claim 1, wherein duct portion is integrally formed with the plate portion.

7. The skid plate of claim 1, wherein the duct portion and the screen are integrally formed with the plate portion.

8. A vehicle, comprising:
a skid plate disposed at an underside of the vehicle, and having a first end disposed proximate to a front end of the vehicle and a second end disposed distally to the front end, the skid plate includes:
a plate portion having a first side disposed facing a ground and a second side disposed opposite to the first side;
a duct portion connected to the plate portion and extending away from the plate portion, the duct portion defining a channel for directing a portion of air flowing underside of the vehicle to the second side; and
a screen disposed at an outlet of the channel for preventing an ingress of debris to the second side from the underside of the vehicle.

9. The vehicle of claim 8, wherein the duct portion includes a cover member oriented at an inclination relative to the plate portion to direct the portion of air along the cover member in a downstream direction towards the second side.

10. The vehicle of claim 9, wherein the cover member includes a first longitudinal end connected to the plate portion and a second longitudinal end disposed spaced apart from the plate portion and defining the outlet therebetween.

11. The vehicle of claim 9, wherein a width of the cover member increases from the first longitudinal end to the second longitudinal end.

12. The vehicle of claim 8, wherein the plate portion defines an elongated opening extending through the plate portion to facilitate an inlet of air to the channel from the underside of the vehicle.

13. The vehicle of claim 12, wherein a width of the elongated opening increases in a downstream direction.

14. The vehicle of claim 8, wherein the duct portion is integrally formed with the plate portion.

15. The vehicle of claim 8, wherein the screen and the duct portion are integrally formed with the plate portion.

16. A skid plate adapted to be disposed at an underside of a vehicle, the skid plate comprising:
a plate portion having a first side adapted to be disposed facing a ground and a second side disposed opposite to the first side;
a duct portion connected to the plate portion and extending away from the plate portion, the duct portion defines a channel for directing a flow of air from the first side to the second side, wherein a width of the channel increases along a direction of flow of air through the channel; and
a screen disposed at an outlet of the channel to prevent an ingress of debris to the second side,
wherein the duct portion and the screen are integrally formed with the plate portion.

17. The skid plate of claim 16, wherein the duct portion includes a cover member extending at an inclination relative to the plate portion and including a first longitudinal end connected to the plate portion and a second longitudinal end disposed spaced apart from the plate portion and defining the outlet therebetween.

18. The skid plate of claim 17, wherein a width of the cover member increases from the first longitudinal end to the second longitudinal end.

19. The skid plat of claim 17, wherein the duct portion includes a pair of sidewalls disposed spaced apart from each other and extending away from the plate portion to the cover member.

20. The skid plate of claim 16, wherein the plate portion defines an elongated opening extending through the plate portion, the elongated opening facilitates an inlet of air into the channel from the first side, wherein the elongated opening diverges along a length of the plate portion.
